(19) United States
(12) Patent Application Publication
(10) Pub. No.: US 2022/0239369 A1
(43) Pub. Date: Jul. 28, 2022

(54) TRANSMISSION DEVICE, RESTORATION METHOD, PROGRAM, AND TRANSMISSION SYSTEM

(71) Applicant: Nippon Telegraph and Telephone Corporation, Tokyo (JP)

(72) Inventors: Kentaro Honda, Musashino-shi, Tokyo (JP); Hideki Maeda, Musashino-shi, Tokyo (JP); Masaaki Inami, Musashino-shi, Tokyo (JP)

(21) Appl. No.: 17/616,545

(22) PCT Filed: Jun. 21, 2019
(86) PCT No.: PCT/JP2019/024730

§ 371 Date: Dec. 3, 2021

(51) Int. Cl. H04B 10/03; H04L 45/247; H04L 1/22; H04B 10/27

(52) U.S. Cl. CPC H04B 10/03; H04B 10/27; H04L 1/22; H04L 45/247

(57) ABSTRACT

A transmission device (1) to replace a failed transmission device is provided with a search unit (12) that searches for an opposite transmission device, a path establishment unit (13) that establishes a communication path passing through the transmission device (1) and the opposite transmission device, an NW construction unit (14) that constructs, by using the established communication path, an individual NW in which at least the transmission device (1) and the opposite transmission device are arranged. In addition, the transmission device (1) is further provided with a restoration support unit (15) for applying setting by an OpS (Operation System) to the transmission device (1).

### TECHNICAL FIELD

The present invention relates to a transmission device, a restoration method, a program, and a transmission system.

In the present description, the “ network” may be described as the “NW”.

### BACKGROUND ART

As an invention that “improves reliability against a failure of a transmitter when multicarrier transmission of a plurality of parallel signals are performed by a plurality of transmitters”, Patent Literature 1 discloses “an optical transmission device provided with a plurality of optical signal transmission units each having a framer that generates a plurality of parallel signals and a plurality of transmitters that perform multicarrier transmission of the plurality of parallel signals generated by the framer using optical subcarriers, including a wavelength switch unit that instructs the transmitter of a switching destination to use a wavelength that the transmitter in which the failure has occurred uses to transmit the optical subcarrier, and in which the framer of a first optical signal transmission unit that is the optical signal transmission unit having the transmitter in which the failure has occurred includes a first optical signal generation unit that outputs a part of client signal received from one or more clients to a second optical signal transmission unit that is the optical signal transmission unit having the transmitter of the switching destination, generates a parallel signal based on the client signal excluding the part of the client signal that has been outputted from the received client signal to the second optical signal transmission unit, and outputs the parallel signal in which the client signal has been set to the transmitter of the first optical signal transmission unit in which a failure has not occurred, and the framer of the second optical signal transmission unit includes a second optical signal generation unit that generates a parallel signal based on the client signal received from the framer of the first optical signal transmission unit, and outputs the generated parallel signal to the transmitter of the switching destination.”

### CITATION LIST

### Patent Literature

Patent Literature 1: Japanese Patent Laid-Open No. 2016-103760

### SUMMARY OF THE INVENTION

### Technical Problem

In a network of a transmission system, when a station house is isolated because a transmission cable is disconnected or a redundant transmission device falls into a failure state of double or more failures due to a large-scale disaster such as an earthquake or a flood, restoration requires enormous time, efforts, and skills. Specifically, since the communication between stations is disabled, it is necessary to perform every restoration work including an initial construction and an NW construction at a site. In addition, though control from an OpS (Operation System) is necessary for restoration of a transmission device and a transmission path, a maintenance worker (in place of the OpS) need to set information (directly to the replacement) before installation, which is originally to be set by the OpS. Therefore, this must be done by a maintenance worker of high skill. Delay in restoration is caused because of a huge number of steps in the restoration work at the site and limitations to workers who can engage in the restoration work.

The technique of Patent Literature 1 can be said to be a technique to effectively utilize another transmitter when a part of the plurality of transmitters provided in the same device fails. However, there is a further problem that when a large-scale disaster occurs, a situation is created in which all devices of the same station fail and the station is isolated, which makes it impossible to adopt the technique of Patent Literature 1 that effectively utilizes another device.

In view of these circumstances, an object of the present invention is to implement quick restoration from a disaster with respect to a transmission system.

### Means for Solving the Problem

In order to solve the above problem, the present invention is a transmission device to replace a failed transmission device, including a search unit that searches for an opposite transmission device, a path establishment unit that establishes a communication path passing through the transmission device and the opposite transmission device, and an NW construction unit that constructs, by using the established communication path, an individual network in which at least the transmission device and the opposite transmission device are arranged.

### Effect of the Invention

According to the present invention, it is possible to implement quick restoration from a disaster with respect to a transmission system.

### BRIEF DESCRIPTION OF DRAWINGS

FIG. 1 is a functional configuration diagram of the transmission device in the present embodiment.

FIG. 2 is a flowchart of restoration processing.

FIG. 3 is a configuration diagram of an example of the transmission system at a normal time (a non-failure time)

FIG. 4 is a configuration diagram of an example of the transmission system at the time of a failure.

FIG. 5 is a configuration diagram of an example of the transmission system when a restoration mode is started.

FIG. 6 is a configuration diagram of an example of the transmission system when restoration is completed.

FIG. 7 is a hardware configuration diagram showing an example of a computer implementing a function of the transmission device.

### DESCRIPTION OF EMBODIMENTS

Hereinafter, with reference to the drawings, an embodiment to implement the present invention (hereinafter, referred to as “the present embodiment”) will be described.

<Configuration>

The transmission device of the present embodiment is a device to be arranged in exchange for a transmission device that has failed due to a disaster or the like (hereinafter, may be referred to as a “failed transmission device”), and is a device in charge of optical transmission between stations. A transmission device 1 is for replacement, in which a setting by an OpS does not exist.

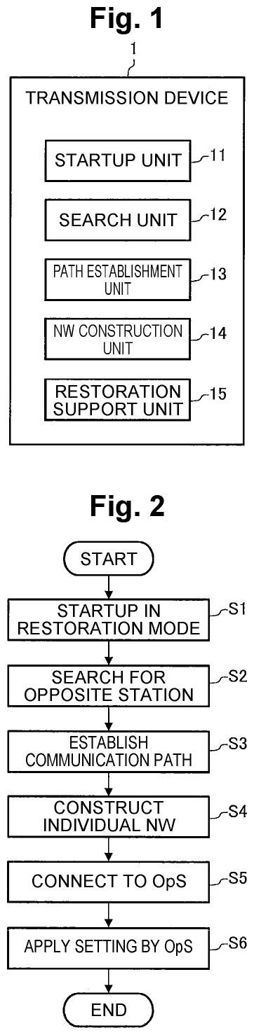

As shown in FIG. 1, the transmission device 1 of the present embodiment is provided with function units such as a startup unit 11, a search unit 12, a path establishment unit 13, an NW construction unit 14, and a restoration support unit 15.

The startup unit 11 executes processing according to the restoration mode when power is applied to the transmission device 1 that is arranged at a predetermined location in exchange for the failed transmission device and is connected to a predetermined transmission path or a predetermined transmission cable. The restoration mode is one of the processing aspects of the transmission device 1, and is the processing aspect that starts after power is applied. The restoration mode can cause the search unit 12, the path establishment unit 13, the NW construction unit 14, and the restoration support unit 15 to operate. In addition, “a predetermined location” can be, for example, a location where the failed transmission device has been arranged, but it is not be limited to this. For example, the predetermined location may be in the vicinity of the location where the failed transmission device has been arranged.

When the transmission path to which the transmission device 1 is to be connected is disconnected due to a disaster or the like, the transmission path is replaced with a transmission path that does not have disconnection or the like, to which the transmission device 1 is connected. In the present embodiment, the disconnection or the like of the transmission path to which the transmission device 1 is to be connected is considered as one aspect of the failures of the failed transmission device.

The search unit 12 searches for a transmission device with which the transmission device 1 can communicate (hereinafter, may be referred to as “an opposite transmission device”). If the opposite transmission device is a transmission device within the station, the search unit 12 is able to detect the opposite station with which the transmission device 1 can communicate. The search by the search unit 12 includes, for example, a colorless wavelength scanning, a directionless route scanning, a long-distance modulation technique of a plurality of kinds of modulation techniques to a transponder, but it is not limited to these.

The colorless wavelength scanning is a function to identify a communication wavelength that enables communication with the opposite transmission device by changing the communication wavelength used for transmission from the transmission device 1. The opposite transmission device without a failure performs transmission using a specific wavelength. However, as the setting by the OpS does not exist in the transmission device 1, it is unknown which wavelength should be used for reception. The colorless wavelength scanning can clarify at which wavelength the transmission device 1 should perform reception.

The directionless route scanning is a function to identify a transmission path to the opposite transmission device by switching the transmission path (route) from the transmission device 1. The failed transmission device is connected to a plurality of transmission paths, but these transmission paths include a transmission path in which communication setting is not practically performed. The directionless route scanning can identify a transmission path that is connected the opposite transmission device and in which the communication setting is performed.

The transmission device supports a plurality of kinds of techniques as modulation techniques of the transponder such as QPSK (Quadrature Phase Shift Keying) or 16QAM (Quadrature Amplitude Modulation). As a modulation technique used for the search of the search unit 12, it is preferable to adopt a modulation technique that implements optical transmission over a transmission range of a predetermined distance or more, from among the modulation techniques supported by the transponder.

The path establishment unit 13 establishes a communication path passing through the transmission device 1 and the opposite transmission device detected by the search of the search unit 12. For example, the established communication path includes an OSC (Optical Supervisory Channel) path and a GCCO (General Communication Channel 0) path, but it is not limited to these.

The NW construction unit 14 constructs an NW in which the transmission device 1 and the detected one or more opposite transmission devices are arranged (hereinafter, may be referred to as an “individual NW”) by using the communication path established by the path establishment unit 13. For example, the NW construction unit 14 can execute automatic IP allocation based on IPv6 (Internet Protocol Version 6) and automatic route selection (routing) by RIP (Routing Information Protocol) when the individual NW is constructed. For this reason, the individual NW can be a low loaded network that does not require presetting.

The restoration support unit 15 executes restoration support processing that is the processing required for restoration by using the individual NW constructed by the NW construction unit 14. Specifically, the restoration support processing includes a process related to a connection of the OpS by way of the individual NW, a process in which the setting by the OpS to the transmission device 1 is received, a process in which the setting by the OpS is applied to the transmission device 1, a process related to a connection to an external device via a management port that is prepared in the individual NW, and a process in which a remote chat and a telephone conference by the external device is received, but it is not limited to these.

<Processing>

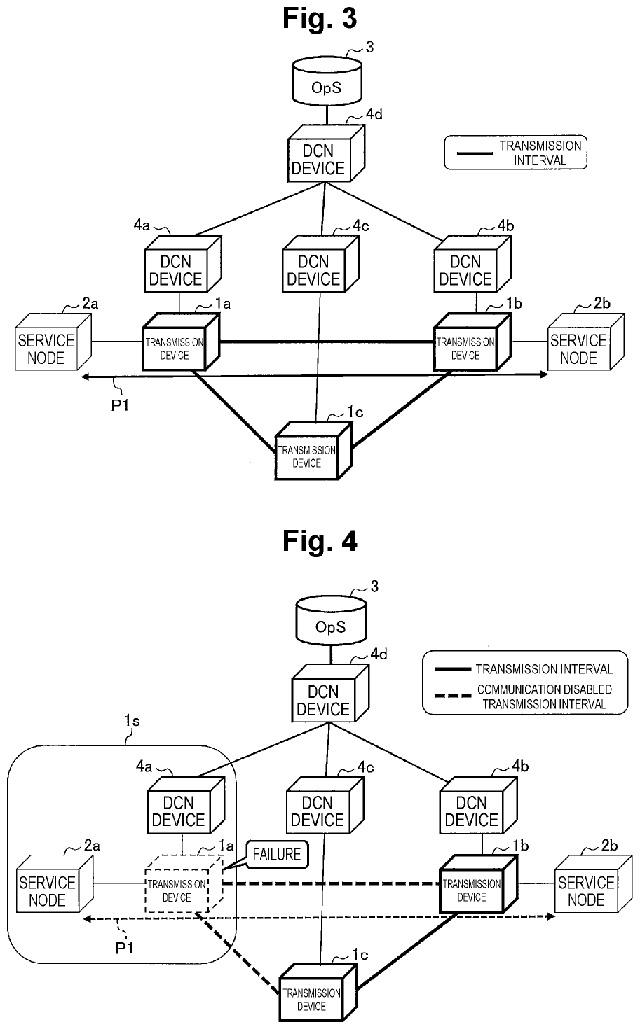

Next, with reference to FIGS. 2 to 6, the restoration processing by the transmission device 1 will be described. FIG. 2 is a flowchart of the restoration processing. FIG. 3 is a configuration diagram of the transmission system at a normal time (a non-failure time), showing an example of the transmission system before a disaster occurs, that is, before the restoration processing is executed. For the convenience of explanation, FIG. 3 will be described first.

The transmission system of FIG. 3 is provided with transmission devices 1a to 1c, service nodes 2a and 2b, an OpS 3, and DCN (Data Communication Network) devices 4a to 4d. The transmission devices 1a to 1c, the service nodes 2a and 2b, the OpS 3, and the DCN devices 4a to 4d are connected in a communicable manner.

The transmission devices 1a to 1c are devices in charge of optical transmission between stations. Transmission intervals of the optical transmission are formed among the transmission devices 1a to 1c. The service nodes 2a and 2b provide a predetermined service by optical communication.

The OpS 3 is a software group that controls and manages the transmission system. The DCN devices 4a to 4d relay information exchanged between the OpS 3 and each of the transmission devices 1a to 1c. The information relayed by the DCN devices 4a to 4d includes a control monitoring signal for the OpS 3 to monitor the transmission devices 1a to 1c, the service nodes 2a and 2b, and the DCN devices 4a to 4d, but it is not limited to these.

At the normal time (the non-failure time), the service nodes 2a and 2b pass through the transmission devices 1a and 1b to establish a communication path P1.

As shown in FIG. 4, it is assumed that due to an occurrence of an accident, the transmission device 1a fails and the transmission system falls into a failure. In this case, communication in the transmission interval between the transmission devices 1a and 1b and the transmission interval between the transmission devices 1a and 1c is disabled, and the communication path P1 disappears. As a result, a station is in which the failed transmission device 1a, the service node 2a, and the DCN device 4a are arranged is isolated and unable to communicate with other stations.

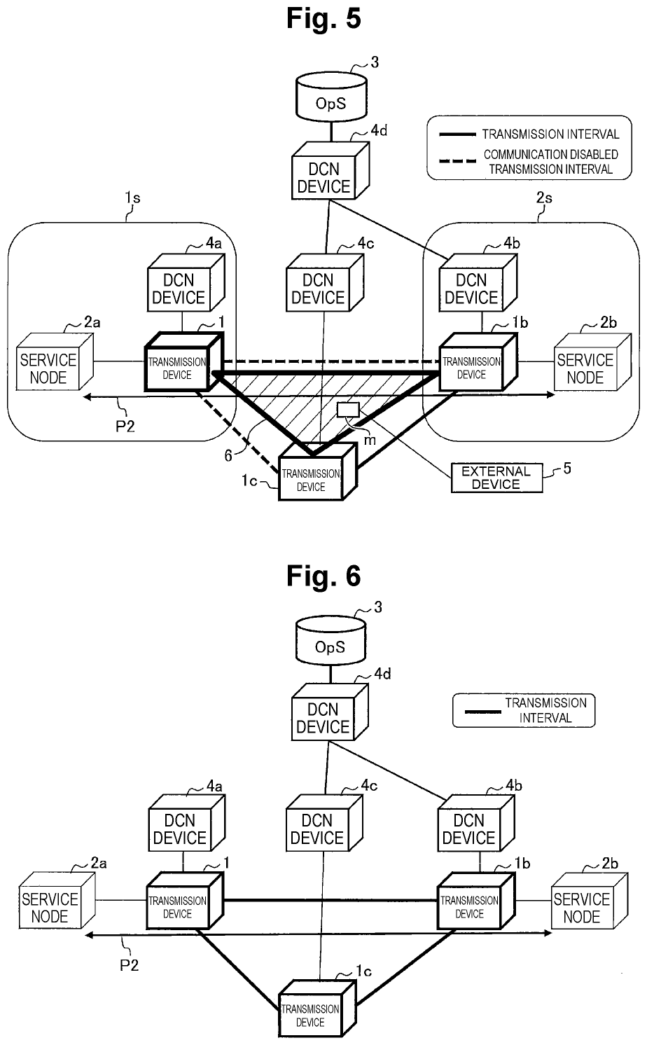

Then, as shown in FIG. 5, the transmission device 1 of the present embodiment is arranged in exchange for the failed transmission device 1a. When the transmission device 1 is connected to the service node 2a and the DCN device 4a as in the transmission device 1a before the disaster and power is applied to the transmission device 1, the restoration processing of FIG. 2 starts.

In the restoration processing of FIG. 2, first, the transmission device 1 starts up in the restoration mode by the startup unit 11 without setting by the OpS 3 (Step S1).

Next, the transmission device 1 causes the search unit 12 to search for the opposite station without the setting by the OpS 3 (Step S2). The search unit 12 identifies the opposite transmission device, for example, by changing a communication wavelength through trial and error with the colorless wavelength scanning, and by changing the transmission path through trial and error with the directionless route scanning. In addition, the search unit 12 may identify the opposite transmission device, for example, by the long-distance modulation technique. In the restoration processing of FIG. 2, it is assumed that the search unit 12 is able to identify the transmission device 1b as the opposite transmission device and detect a station 2s (see FIG. 5) in which the transmission device 1b, the service node 2a, and the DCN device 4a are arranged.

Next, the transmission device 1 causes the path establishment unit 13 to establish a communication path P2 without the setting by the OpS 3 (Step S3). The communication path P2 connects the service nodes 2a and 2b that pass through the replacing transmission device 1 and the transmission device 1b identified by the search unit 12.

Next, the transmission device 1 causes the NW construction unit 14 to constructs an individual NW 6 by using the communication path P2 without the setting by the OpS 3 (Step S4). The individual NW 6 is a low loaded network that does not require presetting, in which the replacing transmission device 1, the transmission device 1b identified by the search unit 12 as the opposite transmission device, and the transmission device 1c searched by the search unit 12 are arranged as shown in FIG. 5. As the individual NW 6 is constructed, communication between the service nodes 2a and 2b can be temporarily performed, which eliminates the isolation of the station 1s.

Next, the transmission device 1 is connected to the OpS 3 via the individual NW 6 by the restoration support unit 15 (Step S5). The OpS 3 can select the replacing transmission device 1 as a target of the restoration. The OpS 3 performs setting for optical transmission to the selected transmission device 1. For example, the setting by the OpS 3 to the transmission device 1 can be the same as the setting performed to the transmission device 1a before the disaster, but it is not limited to this. Note that the content of the setting by the OpS 3 is well-known, and the explanation of the content itself will be omitted.

Note that, as shown in FIG. 5, the NW construction unit 14 can form a management port in the individual NW 6. The management port m is a connection point of an external device 5 having a function of a remote chat and a telephone conference. The restoration support unit 15 supports the remote chat and the telephone conference by the external device 5.

Next, the transmission device 1 causes the restoration support unit 15 to apply the setting by the OpS 3 to the replacing transmission device 1 (Step S6). As shown in FIG. 6, the transmission interval between the transmission devices 1 and 1b and the transmission interval between the transmission devices 1 and 1c are made communicable, thereby implementing communication between the service nodes 2a and 2b without the individual NW 6.

With the above processes, the restoration processing of the transmission device 1 is completed. According to the restoration processing of the transmission device 1 (FIG. 2), the restoration of the transmission system using the replacing transmission device 1 is completed.

<Hardware Configuration>

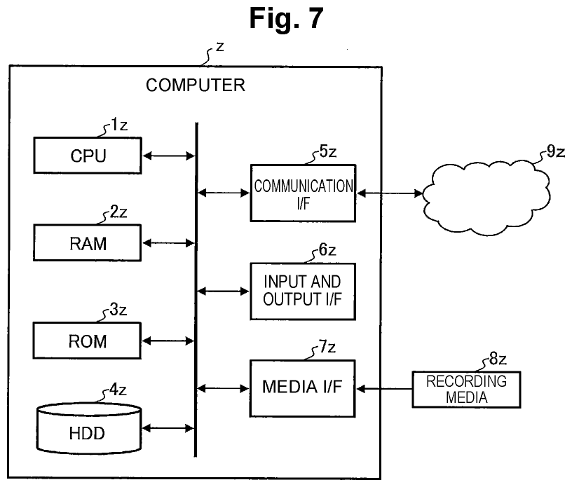

In addition, the transmission device 1 that has been described above is implemented by a computer z that is shown, for example, in a hardware configuration as shown in FIG. 7. The computer z has a CPU 1z, a RAM 2z, a ROM 3z, an HDD 4z, a communication I/F (interface) 5z, an input and output I/F 6z, and a media I/F 7z.

The CPU 1z operates based on a program stored in the ROM 3z or the HDD 4z to control the respective units (including the startup unit 11, the search unit 12, the path establishment unit 13, the NW construction unit 14, and the restoration support unit 15). The ROM 3z stores a boot program executed by the CPU 1z when the computer z is started up, and a program dependent on a hardware of the computer z.

The HDD 4z stores a program executed by the CPU 1z, and data and the like used by the program. The communication I/F 5z receives data from another equipment via a communication network 9z and sends the data to the CPU 1z, and sends data generated by the CPU 1z to another equipment via the communication network 9z.

The CPU 1z controls, via the input and output IF 6z, output devices such as a display and a printer, and input devices such as a keyboard and mouse. The CPU 1z acquires data from the input device via the input and output I/F 6z. In addition, the CPU 1z outputs generated data to the output device via the input and output I/F 6z.

The media I/F 7z reads a program or data stored in a recording medium 8z, and provide the program or the data to the CPU 1z via the RAM 2z. The CPU 1z loads the program from the recording medium 8z to the RAM 2z via the media I/F 7z, and executes the loaded program. For example, the recording medium 8z is an optical recording medium such as a DVD (Digital Versatile Disc) or a PD (Phase change rewritable Disk), a magnetooptical recording medium such as an MO (Magneto Optical disk), a tape media, a magnetic recording media, a semiconductor memory, or the like.

For example, when the computer z functions as the transmission device 1, the CPU 1z of the computer z implements functions of the respective units by executing the programs loaded on the RAM 2z. When the programs are executed, the data or the like stored by the HDD 4z is used. The CPU 1z of the computer z executes these programs by reading these programs from the recording medium 8z. However, as an alternative example, the CPU 1z may obtain these programs from another equipment via the communication network 9z.

<Effects>

As has been described above, the transmission device 1 of the present embodiment is the transmission device 1 to replace the failed transmission device (the transmission device 1a), including the search unit 12 that searches for the opposite transmission device (the transmission device 1b), the path establishment unit 13 that establishes the communication path P2 passing through the transmission device 1 and the opposite transmission device, the NW construction unit 14 that constructs, by using the established communication path P2, the individual NW 6 in which at least the transmission device 1 and the opposite transmission device are arranged.

Thereby, the individual NW 6 is automatically constructed even if the transmission device 1 is arranged at the site in exchange for the failed transmission device by a maintenance worker who is not highly skilled. For this reason, the station 1 that is isolated by the failed transmission device is made communicable with the opposite station (the station 2s) in which the opposite transmission device is arranged, which temporarily eliminate the isolation of the station 1s.

As a result, it is possible to implement quick restoration from a disaster with respect to the transmission system.

In addition, the transmission device 1 of the present embodiment is further provided with the restoration support unit 15 for applying the setting by the OpS (Operation System) to the transmission device 1.

Thereby, completion of the restoration with respect to the transmission system can be implemented because the setting by the OpS 3 is performed in the transmission device 1 in which the setting has not been made by the OpS 3.

In addition, in the transmission device 1 of the present embodiment, the NW construction unit 14 forms the management port m in the constructed individual NW for the external device 5 to be connected to the individual NW.

Thereby, communication by the external device 5 is implemented, which can accelerate the temporal elimination of the isolation of the station 1s.

<Others>

A technique in which various kinds of techniques described in the present embodiment are appropriately combined can also be implemented.

### REFERENCE SIGNS LIST

1, 1a to 1c Transmission devices

11 Startup unit

12 Search unit

13 Path establishment unit

14 NW construction unit

15 Restoration support unit

2a, 2b Service nodes

3 OpS

4a to 4d DCN devices

5 External device

6 individual NW

1. A transmission device to replace a failed transmission device, comprising:
a search unit, including one or more processors, configured to search for an opposite transmission device;
a path establishment unit, including one or more processors, configured to establish a communication path passing through the transmission device and the opposite transmission device;
a network (NW) construction unit, including one or more processors, configured to construct, by using the established communication path, an individual network in which at least the transmission device and the opposite transmission device are arranged.

2. The transmission device according to claim 1, further comprising a restoration support unit, including one or more processors, configured to apply setting by an OpS (Operation System) to the transmission device.

3. The transmission device according to claim 1, wherein the NW construction unit is configured to form a management port in the constructed individual network for an external device to be connected to the individual network.

4. A restoration method executed by a transmission device to replace a failed transmission device, the restoration method comprising:
a step of searching for an opposite transmission device;
a step of establishing a communication path passing through the transmission device and the opposite transmission device; and
a step of constructing, by using the established communication path, an individual network in which at least the transmission device and the opposite transmission device are arranged.

5. The restoration method according to claim 4, further comprising a step of applying setting by an OpS to the transmission device.

6. The restoration method according to claim 4, wherein further comprising a step of forming a management port in the constructed individual network for an external device to be connected to the individual network in the step of constructing the individual network.

7. A non-transitory computer readable medium storing a program to cause a transmission device to execute a restoration method comprising:
a step of searching for an opposite transmission device;
a step of establishing a communication path passing through the transmission device and the opposite transmission device; and
a step of constructing, by using the established communication path, an individual network in which at least the transmission device and the opposite transmission device are arranged.

8. A transmission system comprising the transmission device according to claim 1.

9. The non-transitory computer readable medium according to claim 7, wherein the restoration program further comprises:
a step of applying setting by an OpS to the transmission device.

10. The non-transitory computer readable medium according to claim 7, wherein the restoration program further comprises:
a step of forming a management port in the constructed individual network for an external device to be connected to the individual network in the step of constructing the individual network
